(19) United States
(12) Patent Application Publication
(10) Pub. No.: US 2023/0225027 A1
(43) Pub. Date: Jul. 13, 2023

(54) Buck Boost Lighting System

(71) Applicants: Ainars Pastars, Marupe (LV); Colin Waters, San Fernando, CA (US)

(72) Inventors: Ainars Pastars, Marupe (LV); Colin Waters, San Fernando, CA (US)

(21) Appl. No.: 17/660,126

(22) Filed: Apr. 21, 2022

Related U.S. Application Data
(60) Provisional application No. 63/201,294, filed on Apr. 22, 2021.

(51) Int. Cl. H05B 45/375; H05B 45/38

(52) U.S. Cl. CPC H05B 45/375; H05B 45/38

(57) ABSTRACT

A buck boost system for allowing LED devices to be driven from a longer distance. The boost device boosts the voltage level to a higher level than that used by the eventual LED device. The buck device is powered from that higher voltage, and also reduces the voltage level to a level used by the LED device.

This application claims priority from provisional application No. 63/201,294, filed Apr. 22, 2021, the entire contents of which are herewith incorporated by reference.

### BACKGROUND

Modern lighting devices often use LED lighting elements, which operate at a specified voltage.

To add uniqueness to lighting designs, and instead of using off-the-shelf lighting fixtures, the use of customizable solutions is growing—especially low-voltage LED neons, LED tapes and similar solutions. These give designers the freedom to create unique lighting that would not be possible with generic fixtures. To make these designs even more engaging, pixelation is also sometimes used, allowing segmented control of LED components.

Driving the LEDs at a lower voltage can cause the LEDs to look dim or light in a way that is less than ideal.

These and other customizable LED units require low-voltage, high-current, DC power that is very sensitive to long cable runs, as even a slight voltage drop will cause significant changes in LED brightness and performance. The typical cable length limitation without significant brightness reduction is approximately 32 ft (10 m). When using pixelated LED solutions, control signal degradation reduces this limit to 16 ft (5 m). This means that LED drivers must be located within this distance and AC mains power and control signal cables must be run to this location.

### SUMMARY OF THE INVENTION

The inventor recognized that long wire runs creates a system where electronic devices, particularly LEDs, received less voltage than desirable.

The inventor recognized problems in the conventional system.

LED driver power supplies are bulky - there might be no space to conceal these units near the LED fixtures In such cases, large gauge, heavy, expensive power cables are used between the drivers and the fixtures, to minimize Voltage drop.

Both AC mains and control cables need to be run to this location - in most cases this would mean two conduits or two cables and a clutter of cables near the LED fixtures.

The present application teaches a system using a boost system, and a buck ending part to stabilize the LED voltage.

An embodiment uses existing technology, e.g. a DMX driver, to create power used for an LED.

### BRIEF DESCRIPTION OF THE DRAWINGS

In the Drawings:

the figures show aspects of the invention, and specifically:

FIG. 1 shows a first block diagram of a first embodiment;

FIG. 2 shows a second block diagram of an embodiment intended for indoor use;

FIG. 3 illustrates an end-to-end block diagram; and

FIG. 4 shows an exemplary interface screen.

### DETAILED DESCRIPTION

The present application describes a system for providing a boosted power drive for a light emitting diode (LED) or other similar lighting equipment. Unlike systems in the prior art, this system allows driving the LEDs over a very long distance without losing power. An embodiment describes use of a secondary DC/DC converter that compensates for voltage drop so the power supply can be located at a more remote location.

As low-voltage DC is used, a single cable is run from power supply to LED unit that contains both power and control signal.

An embodiment runs the cable to a remote device: a relatively small box positioned near the LEDs that contains voltage regulation and control signal processing appropriate for the specific LED type. The box positioned near the LEDs does not have its own power supply, but rather uses the power that is provided over the line.

In an embodiment, the power sent over the line can be boosted to a higher value than is necessary for the LED at the source side, and then lowered at the LED side.

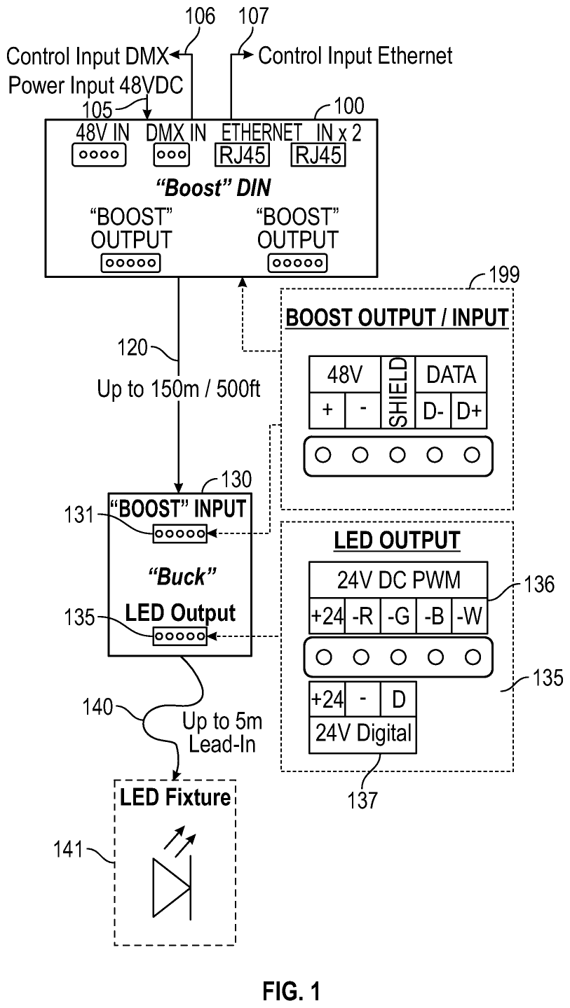

FIG. 1 illustrates an embodiment of a first system. A booster module 100 includes a power input 105 which receives a working voltage, e.g. 36 or 48 V. The box also receives control inputs, either or both of a control input DMX line 106, or control input ethernet 107.

The box creates a boost output shown as 120, which combines power, at 48 V, and data suitable for the specific lighting device. The boosted output is sent over the lines 120, e.g, for a distance of up to 100 m (300 feet) to drive one or more lighting devices. The lighting devices typically require some value less than 48V, such as 5V, 12V or 24 V for their proper operation.

At the location where the lighting device 141 is located, a buck module 130 receives the boost power and data input 120 on its input 131, and creates a reduced output 140 which reduces the power to a suitable voltage and creates a control and power signal 140, typically over 2, 3, 4, or 5 conductors.

FIG. 1 also shows the detailed pin outputs 119 of the boost box. In an embodiment, this includes a 48 V signal, shield, data plus and data minus.

This data for example can be a single color output, an RGB output, an RGBW output, or a pixelated output of various resolutions.

The LED output pinout shown as 135, can allows using a single output module for all different LED types. An analog output 136 pinout can have +24, −R, −G, −B, and −W. These pinouts can be used for single color, dynamic white to color, RGB and RGB W.

There can also be digital signals on the same connector 135, which can include +24 V, a digital signal, and a common.

In this embodiment, the output signal 140 is used to drive a 24 V LED 141 or multiple 24 V LEDs. Preferably, the driving signal is over a short power run, e.g,. a line of 5 m or less to avoid voltage drop.

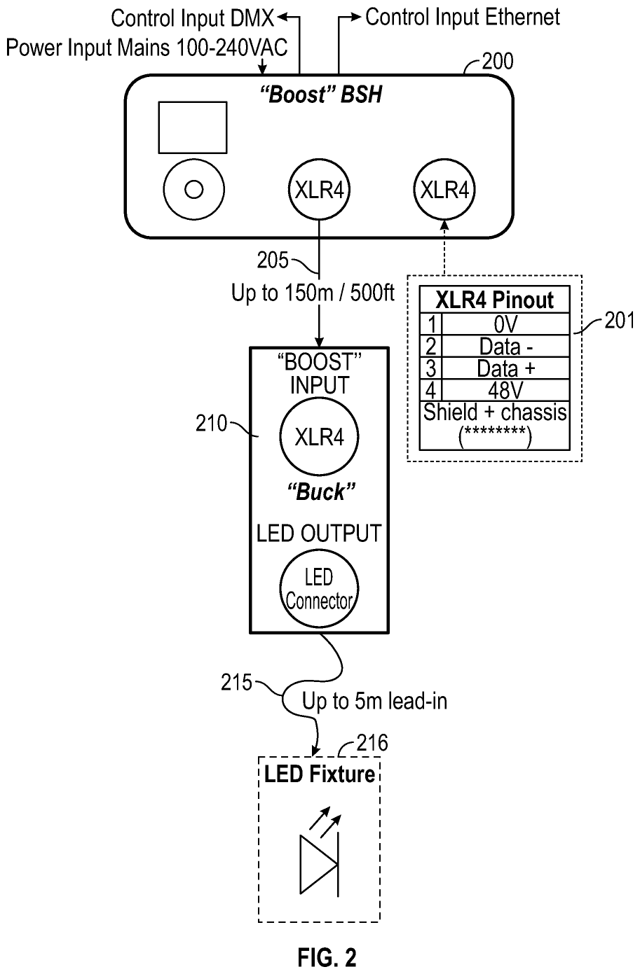

A second embodiment, intended for indoor use, is shown in FIG. 2. This can create boosted outputs using an XLR 4 data format, which has ground, minus data, plus data, and voltage (48 V) having the pin output shown as 201. The booster module 200 produces the output 205. This is then coupled through a long line, e.g, up to 100 m line, to an XLR 4 buck module 210 which receives the XLR signal, and reduces its voltage to 24 V to drive an LED 216 over line 215.

The boost boxes can be DIN Rail and PortableMount “BSH” as well as rack mount versions. These can have any number of outputs, preferably either four outputs or eight outputs

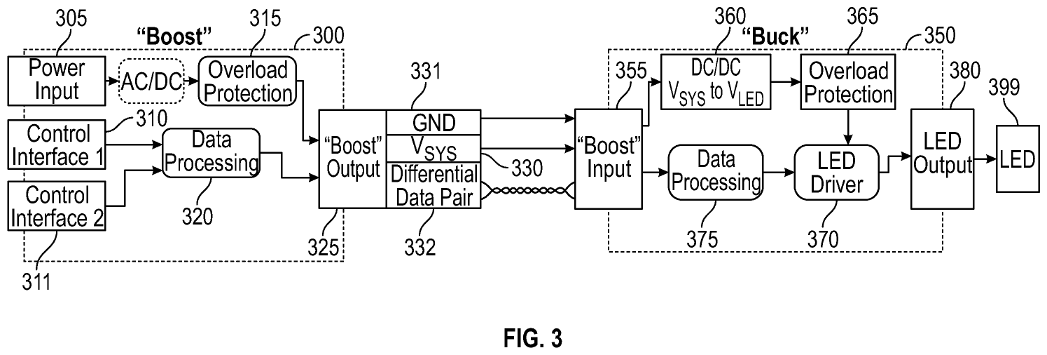

FIG. 3 shows an end to end diagram of the buck and boost units. The boost unit 300, is located in a central location. This receives a power input 305 from the power mains, which can be for example an AC means or a DC power. Control interfaces 310, 311 can receive the control for the desired lighting format. For example, this can be DMX or Ethernet, or other network control, or any other type control as described herein.

An overload protection module 315 monitors the power input, and prevents overpowered output. Data processing 320 is carried out in a conventional processor, and the power and data are combined by a boost output module 325 to create the four line output, including Vsys (e.g, 48 v) 330, ground 331, and a differential data pair 332. These values are received into the buck unit 350. Because this received includes ground and power, the buck unit does not require its own power input. A DC to DC converter 360 down converts the Vsys voltage to the LED desired voltage. This is again checked for overload, and used at 365 and used to drive the LED driver 370.

The LED driver is also driven by the data processing system 375 that produces an output to the LED 380.

The boost voltage Vsys can be any value that is above the LED value typically 24, 36 or 48 V. Importantly, the buck unit 350 does not require its own power supply, thus facilitating putting this in a location near the LED lighting where it can be easily used and that will not require bulky wiring.

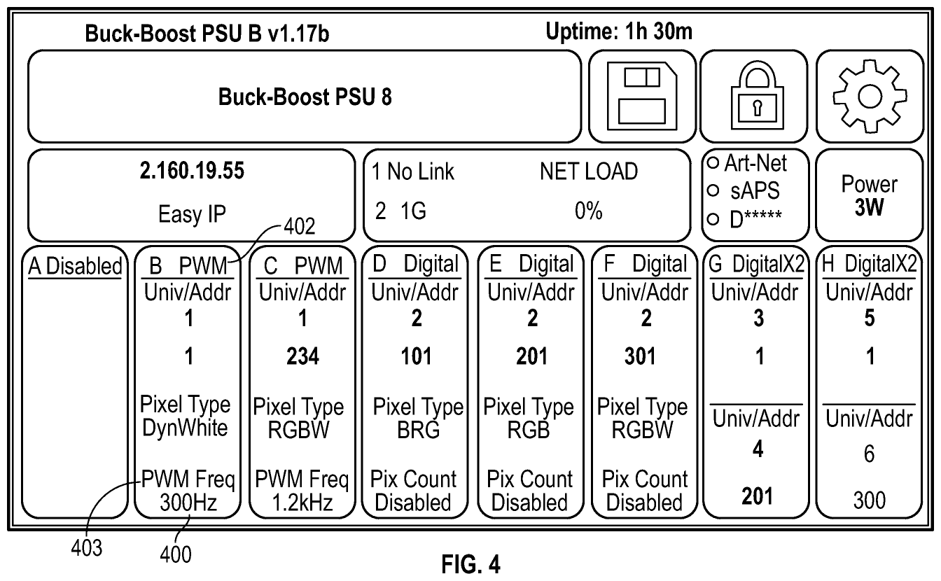

In embodiments, the boost device is configurable, while the the buck device is a single purpose device which is different for different LEDs. The boost box uses a processor, and produces a screen as shown in FIG. 4, showing the different ports that are available for 400, the format of the port 402 here either pulse width modulated or digital. When the port is configured as pulse width modulated, the values can be dynamic white for pixel type RGB W, or other. digitals value can also be BRG, RGB, or RGB W. There can also be a pulse width modulated frequency set at 403. The system also shows a particular device in red if the port is detected to be overloaded.

The above has described the system in terms of conventional formats of control such as DMX and SLR; however it should be understood that any conventional or proprietary signal of this type can be used in this way.

The previous descriptions of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An LED device driving system, comprising:
a boost device, receiving a control input for driving a remote LED device, and receiving a power input, and producing a multiple line output including output signals at a first higher power than is required by the LED device, along with a control signal, on different lines of said multiple line output;
a buck device, remote from the boost device, receiving said multiple line output, and using power from the output signals on said multiple line output to produce an LED device multiple line output for driving the LED device,
the buck device including no connection to mains power, and operating its circuitry from power received on the multiple line output from the boost device, and where the LED device multiple line output includes a lower voltage output than the voltage received on the multiple line output from the boost device.

2. The device as in claim 1, wherein a first higher voltage created by the boost device is 48 V and a second lower voltage created by the buck device is 24 V.

3. The device as in claim 2, wherein the LED device multiple line output is produced on an output connector having multiple outputs, where the multiple outputs includes +24 V, a return signal for the 24 V, and at least one control signal for the LED device.

4. The device as in claim 2, where the boost device produces the multiple line output, which includes 48 V of power, and data for controlling the LED device.

5. The device as in claim 4, wherein the data is DMX data.

6. The device as in claim 4, wherein the data input XLR 4 data.

7. The device as in claim 1, where the voltage output from the boost device is 48 V and the voltage output from the buck device is 24 V.

8. The device as in claim 1, wherein the buck device includes a DC to DC converter receiving the power, and reducing the power from a higher system-level voltage to a lower LED device level voltage, and using the LED device level voltage to power a data processing device which receives and processes data included on the multiple line output.

9. The device as in claim 1, further comprising a user interface on the boost device enabling configuring inputs and outputs of the boost device for different formats and different types of LED devices.

10. The device as in claim 9, wherein the buck device is a single-purpose devices each having a specific LED device type.
